(19) United States
(12) Patent Application Publication
(10) Pub. No.: US 2025/0030682 A1
(43) Pub. Date: Jan. 23, 2025

(54) CONFERENCE SYSTEM FOR AUTHENTICATION OF MULTIPLE DEVICES

(71) Applicant: Capital One Services, LLC, McLean, VA (US)

(72) Inventors: Lee Adcock, Midlothian, VA (US); Mehulkumar Jayantilal GARNARA, Glen Allen, VA (US); Vamsi KAVURI, Geln Allen, VA (US)

(73) Assignee: Capital One Services, LLC, McLean, VA (US)

(21) Appl. No.: 18/224,779

(22) Filed: Jul. 21, 2023

(51) Int. Cl. H04L 9/40

(52) U.S. Cl. CPC H04L 63/0853

(57) ABSTRACT

A conference system is described that authenticates a user using multiple devices. The conference system authenticates a first device and associates the first device with the user. The conference system provides information for a second authentication method to the user. The conference system authenticates a second device by associating the second device with the user.

### BACKGROUND

Improving the operability of online conferencing systems is becoming increasingly important as the demand for remote work increases. In particular, authentication technology for users attempting to log in to a conference session can improve user convenience and security. In addition, it is common these days for one user to own multiple terminals, and for users to log in to meetings at the terminal of their choice.

### BRIEF DESCRIPTION OF THE DRAWINGS/FIGURES

Embodiments of the present disclosure are described with reference to the accompanying drawings. In the drawings, like reference numbers indicate identical or functionally similar elements. Additionally, the leftmost digit(s) of a reference number identifies the drawing in which the reference number first appears. In the accompanying drawings:

FIG. 1 illustrates an example of a conference system in an embodiment of the present disclosure.

FIG. 2 illustrates a block diagram of an example of a conference system in an embodiment of the present disclosure.

FIG. 3 illustrates a flowchart that describes an example of an overview operation of a conference system in an embodiment of the present disclosure.

FIG. 4 illustrates an example of providing information for a second authentication in an embodiment of the present disclosure.

FIG. 5 illustrates an example of providing information for a second authentication in an embodiment of the present disclosure.

FIG. 6 illustrates an example architecture of components implementing a processor system in an embodiment of the present disclosure.

Embodiments of the present disclosure will now be described with reference to the accompanying drawings.

### DETAILED DESCRIPTION

The following embodiments are described in sufficient detail to enable those skilled in the art to make and use the disclosure. It is to be understood that other embodiments are evident based on the present disclosure and that system, process, or mechanical changes may be made without departing from the scope of an embodiment of the present disclosure.

In the following description, numerous specific details are given to provide a thorough understanding of the disclosure. However, it will be apparent that the disclosure may be practiced without these specific details. In order to avoid obscuring an embodiment of the present disclosure, some well-known circuits, system configurations, architectures, and process steps are not disclosed in detail.

The drawings showing embodiments of the system are semi-diagrammatic and not to scale. Some of the dimensions are for the clarity of presentation and are shown exaggeratedly in the drawing figures. Similarly, although the views in the drawings are for ease of description and generally show similar orientations, this depiction in the figures is arbitrary for the most part. Generally, the disclosure may be operated in any orientation.

The term “module,” “engine,” or “unit” referred to herein may include software, hardware, or a combination thereof in an embodiment of the present disclosure in accordance with the context in which the term is used. For example, the software may be machine code, firmware, embedded code, or application software. The software may include instructions stored on a non-transitory storage medium that, when executed by hardware, cause the hardware to perform functions in accordance with those instructions. The hardware may be, for example, circuitry, a processor, a special purpose computer, an integrated circuit, integrated circuit cores, a pressure sensor, an inertial sensor, a microelectromechanical system (MEMS), passive devices, or a combination thereof. Further, if a module, engine, or unit is written in the system or apparatus claims section below, the module, engine, or unit is deemed to include hardware circuitry for the purposes and the scope of the system or apparatus claims.

The modules, engines, or units in the following description of the embodiments may be coupled to one another as described or as shown. The coupling may be direct or indirect, without or with intervening items between coupled modules or units. The coupling may be by physical contact or by communication between modules or units.

### System Overview and Function

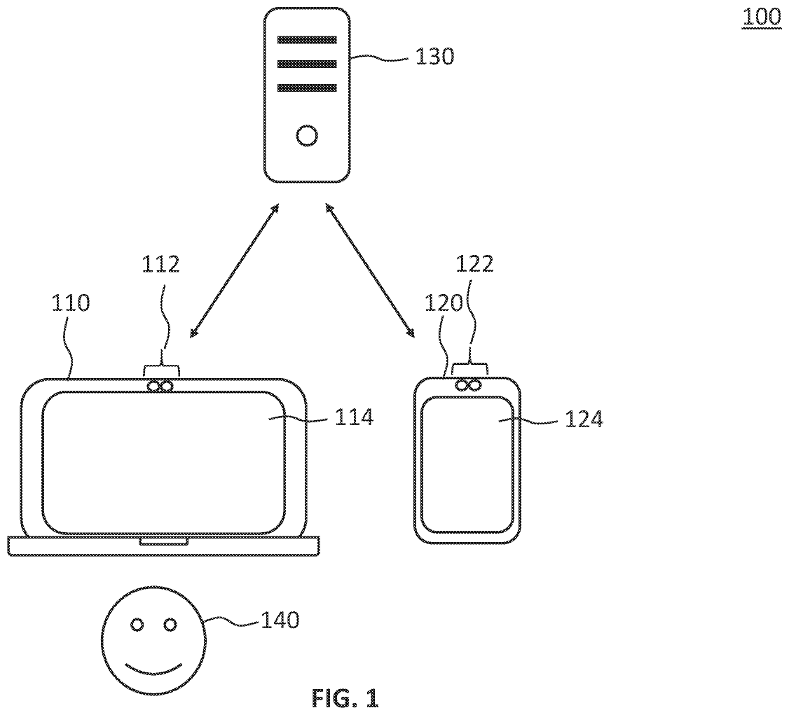

FIG. 1 illustrates an example of a conference system in an embodiment of the present disclosure. System 100 includes a first device 110, a second device 120, and a conference server 130. A user 140 owns the first device 110 and the second device 120. The first device 110 is, for example, a laptop computer having a sensing device 112 and a screen 114. The second device 120 is, for example, a tablet computer having a sensing device 122 and a screen 124. The sensing devices 112 and 122 are, for example, cameras and microphones. The first device 110 transmits an input signal sensed by the sensing device 112, as a first input to the conference server 130. The second device 120 transmits an input signal sensed by the sensing device 122 as a second input to the conference server 130. The laptop computer and the laptop computer are examples of the first device 110, and the second device 120. The first and second electronic devices can be any electronic device that can be connected to the conference server 130. The first and second electronic devices may be, for example, smartphones, desktop computers, dedicated conference terminals, etc.

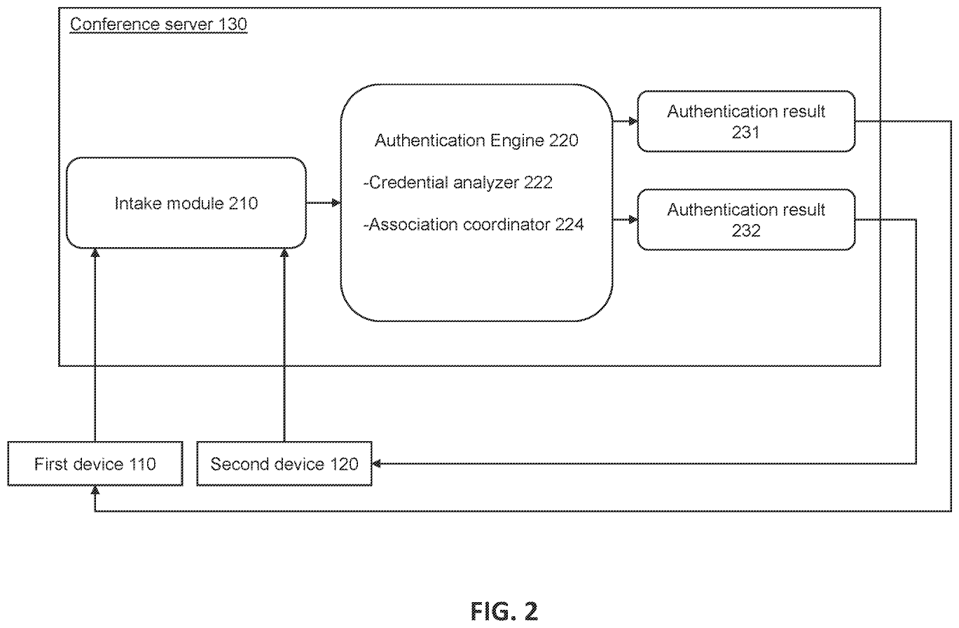

FIG. 2 illustrates an example of a block diagram of the conference system in an embodiment of the present disclosure. In some embodiments, the conference server 130 may be part of a backend computing infrastructure, including a server infrastructure of a company or institution. In some embodiments, the backend computing infrastructure may be implemented in a cloud computing environment. The cloud computing environment may be a public or private cloud service. A private cloud refers to a cloud infrastructure similar to a public cloud, with the exception that it is operated solely for a single organization.

In some embodiments, the conference server 130 may be implemented with modules and sub-modules. For example, the conference server 130 may include an intake module 210, and an authentication engine 220. In some embodiments, the intake module 210 may be coupled to the authentication engine 220. The conference server 130 handles a conference session in which devices, including the first device 110 and the second device 120, participate.

The intake module 210 enables the receipt of one or more inputs, including the first input and the second input, from one or more remote devices, including the first device 110 and the second device 120.

The authentication engine 220 enables authentication based on the received inputs. In some embodiments, the authentication engine 220 includes a credential analyzer 222 and an association coordinator 224. The credential analyzer 222 verifies the credentials of a device attempting to log into a conference session and decides whether or not to allow the device to participate in the conference session. The association coordinator 224 associates user information with one or more devices participating in the conference session based on a result of the determination of the credential analyzer 222. In some embodiments, the authentication engine 220 may be implemented with, or as a part of, a cloud computing service. Such a service may be, for example, Amazon Kinesis Analytics and Insights, Google Cloud Dataflow, or Microsoft Stream Analytics, as examples.

The authentication engine 220 generates a first authentication result 231 and a second authentication result 232. The conference server 130 then sends the first authentication result 231 and the second authentication result 232 to the first device 110 and the second device 120, respectively. The first authentication result 231 and the second authentication result 232 may have the first device 110 and the second device 120, respectively, log into the conference session and associate the first device 110 and the second device 120 with the same user.

### Overview Operations of the Conference System

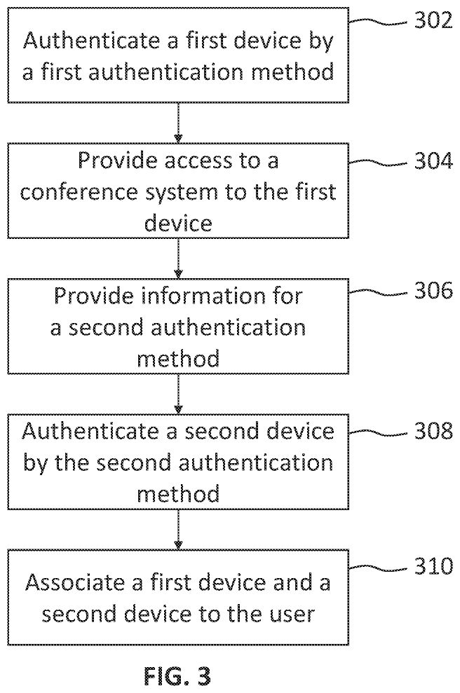

FIG. 3 illustrates a flowchart that describes an example of an overview operation of the conference system. In some embodiments, the operations described below are performed by functional elements of the conference server 130, such as the intake module 210, authentication engine 220, credential analyzer 222, and association coordinator 224, in cooperation with hardware elements such as a processor and memory. Henceforth, when the subject of the description of the operation is simply stated as the conference server 130, it means that one or more of the above-mentioned elements performs the operation.

At operation 302, a first device is authenticated by a first authentication method. In an example, the conference server 130 authenticates the first device 110 by a first authentication method. The first authentication method can be any method that checks whether the information sent by the first device 110 to the conference server 130 is what is required by the conference session held by the conference server 130. In some embodiments, the first authentication method checks the conference password against the user provided password. For example, prior to operation 302, the first device 110 may have sent the conference ID, password, etc. to the conference server 130 for the first authentication method.

In addition to the session information, the user 140 may also send information that identifies the user 140 to the conference server 130. While examples herein may refer to a user ID as the information that identifies the user 140, other types of identification information (e.g., biometric information, username, email address, etc.) may similarly be used. The user ID may also be identified by the conference server 130 from the transmitted conference ID or password. The user ID may also be identified by the conference server 130 by obtaining information unique to the first device 110 from the first device 110. The user ID does not necessarily have to refer to an individual. If the first device is a dedicated conference terminal, the user ID can be general information such as “users in the conference room” or “Conference room A.” The following disclosure assumes that the first authentication method is successful and that the user 140 logs in to the conference session using the first device 110.

At operation 304, the first device is provided with access to a conference system. In an example, the conference server 130 provides the first device 110 with access to a conference system to log in to the conference session facilitated by conference server 130. After operation 304, user 140 will be able to access the conference session (e.g., view, listen to, and/or speak in) the conference session via the first device 110.

At operation 306, information is provided via the conference session for a second authentication method. In an example, the conference server 130 provides information for a second authentication method. The second authentication method is for the user 140 to further log into the same conference session using the second device 120. The user 140 holds (or has the authority to control) both the first device 110 and the second device 120, and depending on the situation in which the user 140 is placed, the user 140 may want to use different devices in the same conference session. For example, an invitation to a conference session may be received only on the first device 110, but the user 140 may want to use a camera and/or microphone on the second device 120. In another example, if the first device 110 is a dedicated conference terminal (which may be used with a large screen) installed in a conference room, actual individual users logged in as “users in the conference room” may want to share data stored on their personal devices in a conference session.

Since there are multiple ways to provide the second authentication method, each will be explained in detail below. The conference server 130 may provide the second authentication method based on a request sent by the first device 110 or the second device 120, or it may provide the second authentication method automatically when the first device 110 logs into the conference session.

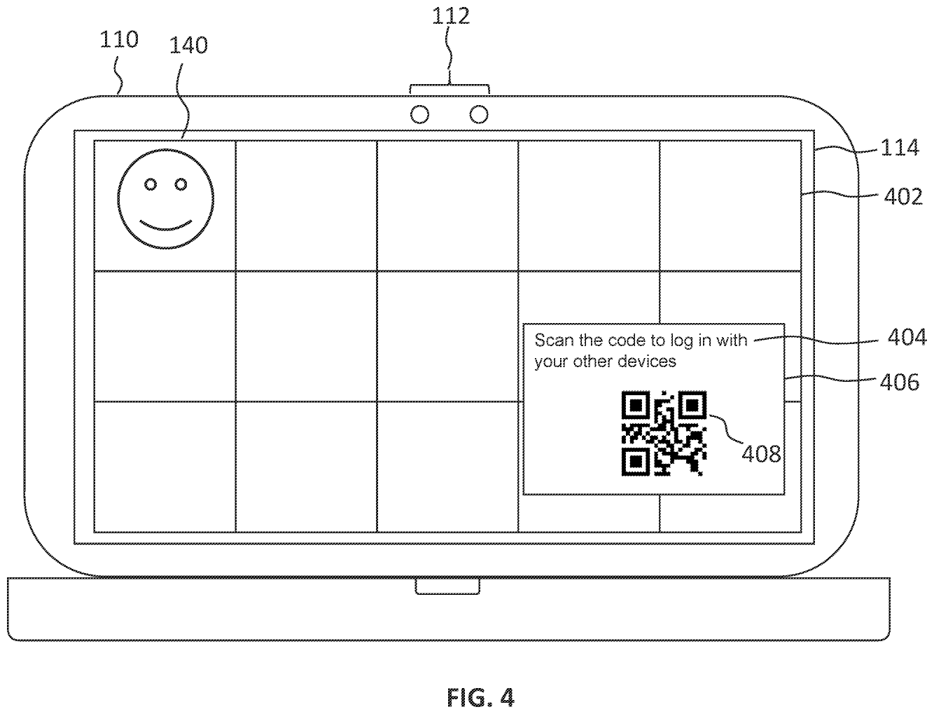

At operation 308, a second device is authenticated by the second authentication method. In an example, the conference server 130 authenticates the second device 120 by the second authentication method. An example of the second authentication method is explained below with respect to FIG. 4. The following disclosure assumes that the second authentication method is successful and that the user 140 logs in to the conference session using the first device 110 and the second device 120.

At operation 310, both the first device and the second device are associated with the same user. In an example, the conference server 130 associates the first device 110 and the second device 120 with the user 140. Two devices being associated with one user ID and participating in a conference session is different from simply having one user participate in the same conference using separate user IDs. The conference server 130 can provide a variety of user experiences by taking advantage of two devices being associated with a single user and participating in a conference session. In some embodiments, video or audio data for user 140 can be provided to only one of the first device 110 or the second device 120 to help save bandwidth and prevent feedback issues. In some embodiments, the conference server 130 ascertains the exact number of participants by using the number of user IDs rather than the number of devices used by user 140 as conference participants. In some embodiments, if the first device 110 is a dedicated conference terminal and individual users in the conference room log in using their personal second device 120, the user environment can be enhanced by, for example, using the voice output from the dedicated conference terminal for the sound heard by individual users and the microphone(s) of the second device(s) for the voice input to record one or more individual user voices.

In some embodiments, the conference server 130 can take advantage of the first device 110 and the second device 120 being owned by the same user 140 to modify the audio or video settings of the conference session. Modifications to the settings include generating higher quality audio input and/or higher quality video input from the inputs from the first device 110 and second device 120. Generating the higher quality audio/video input may include comparing the audio/video inputs of the first device 110 and the second device 120 and selecting the higher quality input. Generating the higher quality audio/video input may include combining the audio/video inputs of the first device 110 and the second device 120 to generate a high-quality input.

In some embodiments, the second authentication method may also reduce the time and effort for the user 140 to duplicate the information previously entered into the first device 110, which is already logged in.

### Second Authentication Method-Provide the Information to the First Device

FIG. 4 illustrates an example of providing the information for the second authentication, in an embodiment of the present disclosure. In an example using the system of FIG. 1, the conference server 130 logs the first device 110 into the conference session by providing access to the conference system 100 to the first device 110 of the user 140. The conference session screen 402 displays the faces and other information of the participants, including the user 140, on the screen 114 of the first device 110. When the user 140 sends a request for the second authentication method to the conference server 130 using the first device 110 or the second device 120, the conference server 130 provides information to the first device 110. The information contains the required information to log the second device 120 into the conference session as an additional device for the user 140 of the first device 110 using the second authentication. In some embodiments, the information contains identification information of the first device 110 and/or user 140. In some embodiments, the conference server 130 provides information on an authentication element 404 to the first device 110 as visible information. The first device 110 displays the authentication element 404 on the screen 114.

In some embodiments, the authentication element 404 may indicate a message 406 and a symbol 408 as visible information. In some embodiments, the message 406 prompts the user 140 to have the symbol sensed by the second device 120. In some embodiments, the symbol 408 provides the second device 120 with information to access the conference server 130 for the second authentication. The symbol 408 may include information representing that the user 140, who is attempting the second authentication by scanning the symbol, is the same user of the first device 110, which is already logged in to the conference session and displaying the symbol.

In some embodiments, the symbol 408 is a Quick Response (QR) code to transition the second device 120 to access the conference server 130 for the second authentication. User 140 scans the QR code using the sensing device 122 (such as a camera) of the second device 120. The second device 120 decodes the QR code and accesses the conference server 130 for the second authentication.

In some embodiments, the symbol 408 is or includes text of an access code, password, and/or user ID or other related information required for the second authentication. In some embodiments, user 140 scans the text as an image by using the sensing device 122 of the second device 120. The second device 120 converts the scanned image to text by using, for example, optical character recognition (OCR) and accesses the conference server 130 with information on the text for the second authentication. In some embodiments, the text may include a Uniform Resource Locator (URL) to access the conference server 130 for the second authentication.

In some embodiments, the visible information may be only visible to the sensing device 122. The visible information may include modulated light of a given wavelength.

The visible information does not necessarily have to be displayed at the request of user 140. In some embodiments, the visible information may be included in the invitation sent to the first device 110 for the first authentication.

In some embodiments, instead of or in addition to the authentication element 404, the conference server 130 may cause the first device 110 to play audio containing a specific frequency pattern as audio information for the second authentication. In some embodiments, user 140 records the audio information using a microphone of the sensing device 122 of the second device 120. The audio information may be modulated to carry the information required for the second authentication, and the second device decodes the recorded audio signal to access the conference server 130 for the second authentication. Sound information may be audible or non-audible to typical human hearing.

As mentioned above, in some embodiments the conference server 130 provides information to the first device 110, which in turn provides information to the user 140. When the sensing device 122 of the second device 120 senses the information, the second device 120 accesses the conference server 130 and sends the information obtained by the result of the sensing. In some embodiments, the conference server 130 obtains the identification information of the second device 120 before the second authentication. The conference server 130 may verify the identification information of the second device 120 with the identification information provided during the second authentication. The conference server 130 may confirm that the same user 140 is using the first device 110 and the second device 120 based on the result of the verification. The conference server 130 performs a second authentication of the second device 120 based on the information received from the second device 120. If the authentication is successful, the conference server 130 logs the second device 120 into the conference session as an additional device associated with the user 140.

### Second Authentication Method-Provide the Information to the Second Device

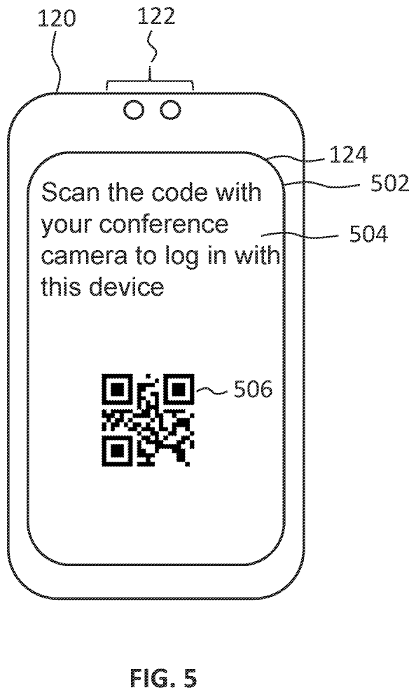

FIG. 5 illustrates an example of providing information for a second authentication in an embodiment of the present disclosure. In an example using the system of FIG. 1, the conference server 130 logs the first device 110 into the conference session by providing access to the conference system 100 to the first device 110 of the user 140. When the user 140 sends a request for the second authentication method to the conference server 130 using the first device 110 or the second device 120, the conference server 130 provides information for a conference application installed in the second device 120. The information contains the required information to log the second device 120 into the conference session as an additional device for the user 140 of the first device 110 using the second authentication method. In some embodiments, the information contains identification information of the first device 110. In response to the receipt of the information, the second device 120 displays an application interface 502 on the screen 124. The application interface 502 displays visible information for the second authentication.

In some embodiments, the application interface 502 may indicate a message 504 and a symbol 506 as visible information. In some embodiments, the message prompts the user 140 to have the symbol sensed by the first device 110. In some embodiments, the symbol provides the second device 120 with information to access the conference server 130 for the second authentication. The symbol 506 may include information representing that the user 140 attempting the second authentication by scanning the symbol is the same user 140 of the first device 110, which is already logged in to the conference session and displaying the symbol.

In some embodiments, the symbol 506 is a QR code to transition the first device 110 to access the conference server 130 for the second authentication. User 140 scans the QR code by using the sensing device 112 (such as a camera) of the first device 110. The first device 110 decodes the QR code and accesses the conference server 130 for the second authentication.

In some embodiments, the symbol 506 is or includes text of an access code, password, and/or user ID or other related information required for the second authentication. In some embodiments, user 140 scans the text as an image by using the sensing device 112 of the first device 110. The first device 110 converts the scanned image to the text by using, for example, OCR and accesses the conference server 130 with information on the text for the second authentication. In some embodiments, the text may include a URL to access the conference server 130 for the second authentication.

In some embodiments, the visible information may be only visible to the sensing device 112. The visible information may include modulated light of a given wavelength.

The visible information does not necessarily have to be displayed at the request of user 140. In some embodiments, the visible information may be included in the invitation sent to the second device 120 for the first authentication.

In some embodiments, instead of or in addition to the application interface 502, the conference server 130 may cause the second device to play audio containing a specific frequency pattern as audio information for the second authentication. In some embodiments, user 140 records the audio information by using a microphone of the sensing device 112 of the first device 110. The audio information may be modulated to carry the information required for the second authentication, and the second device decodes the recorded audio signal to access the conference server 130 for the second authentication. Sound information may be audible or non-audible to typical human hearing.

As mentioned above, in some embodiments the conference server 130 provides information to the second device 120, which in turn provides information to the user 140. When the sensing device 112 of the first device 110 senses the information, the first device 110 accesses the conference server 130 and sends the information obtained by the result of the sensing. In some embodiments, the conference server 130 obtains the identification information of the first device 110 before the second authentication. The conference server 130 may verify the identification information of the first device 110 with the identification information provided during the second authentication. The conference server 130 may confirm that the same user 140 is using the first device 110 and the second device 120 based on the result of the verification. The conference server 130 performs a second authentication of the second device 120 based on the information received from the first device 110. If the authentication is successful, the conference server 130 logs the second device 120 into the conference session as an additional device associated with the user 140.

### Components of the System

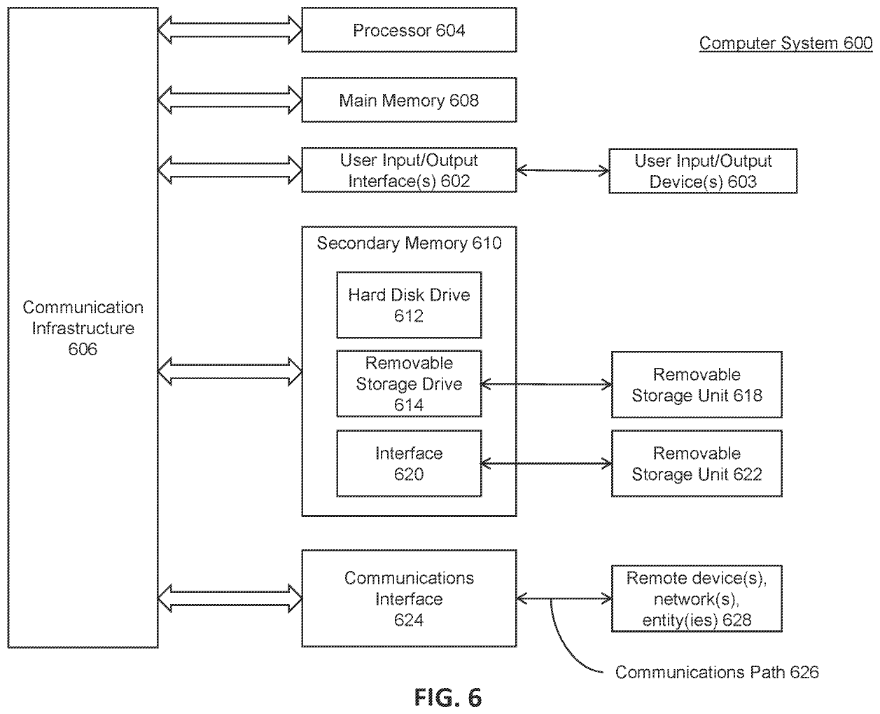

Various aspects of the above disclosure can be implemented, for example, using one or more processor systems, such as processor system 600 shown in FIG. 6. Processor system 600 can be any well-known computer capable of performing the functions described herein such as the first device 110, the second device 120, or the conference server 130 of FIG. 1. Processor system 600 includes one or more processors (also called central processing units, or CPUs), such as a processor 604. Processor 604 is connected to a communication infrastructure 606 (e.g., a bus.) Processor system 600 also includes user input/output device(s) 603, such as monitors, keyboards, pointing devices, etc., that communicate with communication infrastructure 606 through user input/output interface(s) 602. Processor system 600 also includes a main or primary memory 608, such as random access memory (RAM). Main memory 608 may include one or more levels of cache. Main memory 608 has stored therein control logic (e.g., computer software) and/or data.

Processor system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 includes a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 reads from and/or writes to removable storage unit 618 in a well-known manner.

According to some aspects, secondary memory 610 may include other means, instrumentalities or other approaches for allowing computer programs and/or other instructions and/or data to be accessed by processor system 600. Such means, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Processor system 600 may further include communication or network interface 624. Communication interface 624 enables processor system 600 to communicate and interact with any combination of remote devices, remote networks, remote entities, etc. (individually and collectively referenced by reference number 628). For example, communication interface 624 may allow processor system 600 to communicate with remote devices 628 over communications path 626, which may be wired and/or wireless, and may include any combination of LANs, WANs, the Internet, etc. Control logic and/or data may be transmitted to and from processor system 600 via communication path 626.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, processor system 600, main memory 608, secondary memory 610 and removable storage units 618 and 622, as well as tangible articles of manufacture embodying any combination of the foregoing. Such control logic, when executed by one or more data processing devices (such as processor system 600), causes such data processing devices to operate as described herein.

Based on the teachings contained in this disclosure, it will be apparent to persons skilled in the relevant art(s) how to make and use aspects of the disclosure using data processing devices, computer systems and/or computer architectures other than that shown in FIG. 6. In particular, aspects may operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for a conference system, the computer-implemented method comprising:
authenticating, by the conference system, a first device by a first authentication method, wherein the authenticating associates the first device with a user;
providing, by the conference system, access to the conference system to the first device based on the first device being associated with the user;
providing, by the conference system, information for a second authentication method to at least one of the first device and a second device;
authenticating, by the conference system, the second device by the second authentication method, wherein the authenticating the second device associates the second device with the user; and
providing, by the conference system, access to the conference system to the second device based on the second device being associated with the user.

2. The computer-implemented method of claim 1, wherein:
providing, by the conference system, information for a second authentication method comprises providing, by the conference system, information for a second authentication method to the first device; and
the second authentication method comprises sensing the information using a sensing device of the second device.

3. The computer-implemented method of claim 2, wherein:
the information is visible information;
the sensing device is a camera of the second device; and
sensing the information using a sensing device of the second device comprises sensing the visible information shown in the first device by using the camera.

4. The computer-implemented method of claim 2, wherein:
the visible information is shown in a conference screen of the first device.

5. The computer-implemented method of claim 2, wherein:
the information is audio information;
the sensing device is a microphone of the second device; and
sensing the information using a sensing device of the second device comprises sensing the audio information played by the first device by using the microphone.

6. The computer-implemented method of claim 1, wherein:
providing, by the conference system, information for a second authentication method comprises providing, by the conference system, information for a second authentication method to the second device; and
the second authentication method comprises sensing the information using a sensing device of the first device.

7. The computer-implemented method of claim 6, wherein:
the information is visible information;
the sensing device is a camera of the first device; and
sensing the information using a sensing device of the first device comprises sensing the visible information shown in the second device by using the camera.

8. A conference system, comprising:
a memory configured to store operations; and
one or more processors configured to perform the operations, the operations comprising:
authenticating a first device by a first authentication method, wherein the authenticating associates the first device with a user;
providing access to the conference system to the first device based on the first device being associated with the user;
providing information for a second authentication method to at least one of the first device and a second device;
authenticating the second device by the second authentication method, wherein the authenticating the second device associates the second device with the user; and
providing access to the conference system to the second device based on the second device being associated with the user.

9. The conference system of claim 8, wherein:
providing, by the conference system, information for a second authentication method comprises providing, by the conference system, information for a second authentication method to the first device; and
the second authentication method comprises sensing the information using a sensing device of the second device.

10. The conference system of claim 9, wherein:
the information is visible information;
the sensing device is a camera of the second device; and
sensing the information using a sensing device of the second device comprises sensing the visible information shown in the first device by using the camera.

11. The conference system of claim 9, wherein:
the visible information is shown in a conference screen of the first device.

12. The conference system of claim 9, wherein:
the information is audio information;
the sensing device is a microphone of the second device; and
sensing the information using a sensing device of the second device comprises sensing the audio information played by the first device by using the microphone.

13. The conference system of claim 8, wherein:
providing, by the conference system, information for a second authentication method comprises providing, by the conference system, information for a second authentication method to the second device; and
the second authentication method comprises sensing the information using a sensing device of the first device.

14. The conference system of claim 13, wherein:
the information is a visible information;
the sensing device is a camera of the first device; and
sensing the information using a sensing device of the first device comprises sensing the visible information shown in the second device by using the camera.

15. A computer readable storage device having instructions stored thereon, execution of which, by one or more processing devices, causes the one or more processing devices to perform operations comprising:
authenticating a first device by a first authentication method, wherein the authenticating associates the first device with a user;
providing access to the conference system to the first device based on the first device being associated with the user;
providing information for a second authentication method to at least one of the first device and a second device;
authenticating the second device by the second authentication method, wherein the authenticating the second device associates the second device with the user; and
providing access to the conference system to the second device based on the second device being associated with the user.

16. The computer readable storage device of claim 15, wherein:
providing, by the conference system, information for a second authentication method comprises providing, by the conference system, information for a second authentication method to the first device; and
the second authentication method comprises sensing the information using a sensing device of the second device.

17. The computer readable storage device of claim 16, wherein:
the information is a visible information;
the sensing device is a camera of the second device; and
sensing the information using a sensing device of the second device comprises sensing the visible information shown in the first device by using the camera.

18. The computer readable storage device of claim 16, wherein:
the information is audio information;
the sensing device is a microphone of the second device; and
sensing the information using a sensing device of the second device comprises sensing the audio information played by the first device by using the microphone.

19. The computer readable storage device of claim 15, wherein:
providing, by the conference system, information for a second authentication method comprises providing, by the conference system, information for a second authentication method to the second device; and
the second authentication method comprises sensing the information using a sensing device of the first device.

20. The computer readable storage device of claim 19, wherein:
the information is visible information;
the sensing device is a camera of the first device; and
sensing the information using a sensing device of the first device comprises sensing the visible information shown in the second device by using the camera.
